(19) United States
(12) Patent Application Publication
(10) Pub. No.: US 2011/0012797 A1
(43) Pub. Date: Jan. 20, 2011

(54) ANTENNA ELEMENT AND PORTABLE RADIO

(75) Inventors: Kazuya Tani, Osaka (JP); Tomoaki Nishikido, Miyagi (JP); Hironori Kikuchi, Miyagi (JP); Yoshio Koyanagi, Kanagawa (JP); Kenichi Sato, Miyagi (JP); Hiroaki Ohmori, Miyagi (JP)

Correspondence Address: Seed Intellectual Property Law Group PLLC, 701 Fifth Avenue, Suite 5400, Seattle, WA, 98104, US

(73) Assignee: PANASONIC CORPORATION, Osaka (JP)

(21) Appl. No.: 12/922,142

(22) PCT Filed: Dec. 24, 2008
(86) PCT No.: PCT/JP2008/003937

§ 371 Date: Sep. 10, 2010

(30) Foreign Application Priority Data
Mar. 11, 2008 (JP) 2008-061306

(51) Int. Cl. H01Q 1/24; H01Q 1/48; H01Q 7/06

(52) U.S. Cl. 343/702; 343/848; 343/787

(57) ABSTRACT

An antenna element 5 includes a substantially rectangular first conductor plate 51 that is arranged at a predetermined space S from a lower circuit board (a ground plate) 21 and in the vicinity of a hinge 4; a substantially rectangular second conductor plate 52 that shares one widthwise side of the first conductor plate 51 and that is placed while bent at an angle of about 90° with respect to the first conductor plate; and a substantially rectangular third conductor plate 53 that shares another widthwise side of the second conductor plate 52 opposing the one side of the second conductor plate 52 shared by the first conductor plate 51 and that is arranged at an angle of about 90° so as to oppose the first conductor plate 51. The rectangular parallelepiped antenna element 5 is formed by folding a rectangular, board-shaped monopole element into two faces or more.

### TECHNICAL FIELD

The present invention relates to an antenna element and a portable radio equipped with the antenna element.

### BACKGROUND ART

In recent times, there is a growing desire to add a plurality of radio systems; for instance, GPS functions and Bluetooth (registered trademark) functions, to a portable radio (e.g., a portable phone). When an attempt is made to provide a plurality of radio systems to a portable phone, a range of a working frequency band becomes broader. For instance, the portable phone must be made compatible with a 1.5 G band for a GPS and 2.4 GHz band for a Bluetooth as well as with three bands; namely, an 800 MHz band, a 1.7 GHz band, and a 2 GHz band that are used for communication on a portable phone. Accordingly, when an attempt is made to provide such a plurality of radio systems to the portable phone, a built-in antenna must assure predetermined antenna performance with respect to a plurality of frequency bands.

As shown in FIG. 40, a rectangular parallelepiped antenna element 200 is also proposed (see; for instance, Patent Document 1). Specifically, the antenna 200 includes the rectangular parallelepiped antenna element 201 whose minimum side is smaller than λ/8 (where λ: a wavelength) and that is connected to a coaxial cable 202 and placed in close proximity to a ground plate 202. There is provided a description stating that the frequency band of the portable radio system can be made broader by use of the foregoing rectangular parallelepiped antenna element 202.

An antenna element described in connection with Patent Document 2 shown in FIG. 41 has already been known as such a rectangular parallelepiped antenna element. For instance, in an antenna element 300 described in connection with Patent Document 2, a conductor plate 301 is connected to a conductor ground plate 303 by way of a metallic wire 302 and is fed with electric power from a feed point 305 by way of a metallic wire 304, as shown by (A) in FIG. 41. On the contrary, a conductor wall 306 whose one end is electrically connected to the conductor plate 301 has another end electrically connected to an electromagnetic field coupling adjustment plate 307. As shown by (B) in FIG. 41, the electromagnetic field coupling adjustment plate 307 is arranged at a predetermined space from the conductor ground plate 303, thereby forming a capacitor between the electromagnetic field coupling adjustment plate and the conductor plate 303.

Incidentally, for instance, an attempt is made to lower the frequency of the antenna element 300 by placing the conductor wall 306 and the electromagnetic field coupling adjustment plate 307 such that a path length from a point where the metallic wire 302 is connected to the conductor plate 301 to an open end of the electromagnetic field coupling adjustment plate 307 becomes longer. In particular, a current path extending from a feeding point where the metal wire 304 is connected to the conductor plate 301 to a short-circuit point is arranged so as to come to one-half of a desired resonance frequency, whereby both lowering of an antenna resonance frequency and broadening of a frequency characteristic are accomplished.

Patent Document 1: JP-A-2006-279159

Patent Document 2: JP-A-2002-223114

### DISCLOSURE OF THE INVENTION

### Problem that the Invention is to Solve

An increase in the size of the antenna element is imperative even for a compact antenna, such as that described in connection with Patent Document 2, in order to cover a low frequency band. Further, the antenna element is a board-shaped antenna assuming the form of the inverted letter F, a ground plate must be placed beneath the element. In order to achieve a broad band, a distance of about 7 mm must exist between the antenna element and the ground plate, which is unsuitable for slim equipment, such as a portable radio.

On the contrary, when a half of the antenna element 202 is surrounded by a close ground plate 202 as described in connection with Patent Document 1, the range of the band tends to become smaller and a radiation efficiency also tends to become worse when compared with a case where the ground plate is not provided.

The present invention has been conceived in view of the circumstance and aims at providing an antenna element and a portable radio that are compact; that achieve a high gain; and that is compatible with a broader frequency band and multiple bands.

### Means for Solving the Problems

An antenna element according to the present invention is configured by comprising: a substantially rectangular first conductor plate arranged at a predetermined space apart from a ground plate; a substantially rectangular second conductor plate that shares one widthwise side of the first conductor plate and that is arranged at an angle of about 90° with respect to the first conductor plate; and a substantially rectangular third conductor plate that shares another widthwise side of the second conductor plate opposing the one side of the second conductor plate shared by the first conductor plate and that is arranged at an angle of about 90° so as to oppose the first conductor plate, wherein electric power is fed to the first conductor plate from a substantial corner of the ground plate.

A portable radio according to the present invention is configured by including a first housing accommodating a ground plate of the portable radio, a second housing having a first antenna element, and a hinge that connects the first housing to the second housing and that holds the second housing rotatably with respect to the first housing, wherein the antenna element defined in claim 1 is provided in vicinity of the hinge.

In the portable radio, it is preferable that the first antenna element provided in the second housing is capacitively coupled to any one of the first conductor plate, the second conductor plate, and the third conductor plate provided in the antenna element defined in claim 1, thereby operating as a composite antenna.

In the portable radio, it is preferable that, in addition to having the first conductor plate, the second conductor plate, and the third conductor plate configuring the antenna element defined in claim 1, the antenna element has a fourth conductor plate sharing one side of the first conductor plate, one side of the second conductor plate, and one side of the third conductor plate.

It is preferable that the antenna element further comprises a fourth conductor plate sharing one side of the first conductor plate, one side of the second conductor plate, and one side of the third conductor plate.

It is preferable that the antenna element further comprises a fifth conductor plate that is arranged at a position opposing the fourth conductor plate with the first conductor plate, the second conductor plate, and the third conductor plate sandwiched between the fourth and fifth conductor plates and that shares one side of the first conductor plate, one side of the second conductor plate, and one side of the third conductor plate, wherein the fifth conductor plate is arranged on a side surface of the first conductor plate in proximity to a feeding point on the first conductor plate where electric power is fed from the ground plate.

It is preferable to configure the antenna element, wherein the fourth conductor plate is arranged on a side surface of the first conductor plate apart from a feeding point on the first conductor plate where electric power is fed from the ground plate, and the antenna element includes: a sixth conductor plate that extends from one side of the fourth conductor plate which shares neither one side of the first conductor plate, one side of the second conductor plate, nor one side of the third conductor plate and that is arranged at an angle of 90° with respect to the fourth conductor plate; and a slit existing between the sixth conductor plate and the first conductor plate and between the sixth conductor plate and the third conductor plate.

It is preferable to configure the antenna element, wherein the one side of the sixth conductor plate extending from the fourth conductor plate has a defect in part.

It is preferable to configure the antenna element, further comprising a fifth conductor plate that is arranged at a position opposing the fourth conductor plate with the first conductor plate, the second conductor plate, and the third conductor plate sandwiched between the fourth and fifth conductor plates and that shares one side of the first conductor plate, one side of the second conductor plate, and one side of the third conductor plate.

It is preferable to configure the antenna element, wherein the sixth conductor plate is formed from an elongated line into a meander shape.

It is preferable to configure the antenna element, wherein a space defined by the first conductor plate, the second conductor plate, and the third conductor plate is filled with a dielectric material or a magnetic material.

An antenna element according to the present invention is configured by comprising: a substantially rectangular first conductor plate arranged at a predetermined space apart from a ground plate; a substantially rectangular second conductor plate that shares one widthwise side of the first conductor plate and that is arranged at an angle of about 90° with respect to the first conductor plate; a fourth conductor plate that is provided on a side surface of the first conductor plate apart from a feeding point where electric power is fed from the ground plate and that shares one side of the first conductor plate and one side of the second conductor plate; and a sixth conductor plate and a seventh conductor plate that extend from two adjoining sides of the fourth conductor plate which are shared by neither the one side of the first conductor plate nor the one side of the second conductor plate and that are arranged at an angle of about 90° with respect to the fourth conductor plate.

It is preferable to configure the antenna element, further comprising a third conductor plate that shares another widthwise side of the second conductor plate opposing the one side of the second conductor plate shared by the first conductor plate and that is arranged at an angle of about 90° so as to oppose the first conductor plate.

It is preferable to configure the antenna element, wherein the sixth conductor plate and the seventh conductor plate share one side with each other, to thus form an L-shaped folded portion.

It is preferable to configure the antenna element, wherein a defect is provided in a part of a side of at least the sixth conductor plate or the seventh conductor plate extending from the fourth conductor plate.

It is preferable to configure the antenna element, further comprising a fifth conductor plate that is arranged at a position opposing the fourth conductor plate with the first conductor plate and the second conductor plate sandwiched between the fourth and fifth conductor plates and that shares the one side of the first conductor plate and the one side of the second conductor plate.

It is preferable to configure the antenna element, wherein the sixth conductor plate or the seventh conductor plate is formed from an elongated line into a meander shape.

It is preferable to configure the antenna element, wherein a space defined by the first conductor plate, the second conductor plate, and the fourth conductor plate is filled with a dielectric material or a magnetic material.

An antenna element according to the present invention is configured by comprising: a substantially rectangular first conductor plate arranged at a predetermined space apart from a ground plate; a fourth conductor plate that shares a heightwise side of the first conductor plate apart from a feeding point on the first conductor plate where electric power is fed from the ground plate and that is arranged at an angle of about 90° with respect to the first conductor plate; a substantially rectangular third conductor plate that shares another side opposing the one side of the fourth conductor plate shared by the first conductor plate and that is arranged at an angle of about 90° so as to oppose the first conductor plate; and a sixth conductor plate and a seventh conductor plate that extend from two opposing sides of the fourth conductor plate which share neither the one side of the first conductor plate nor the one side of the third conductor plate and that are arranged at an angle of about 90° with respect to the fourth conductor plate.

It is preferable to configure the antenna element, further comprising a second conductor plate that shares a part of one widthwise side of the first conductor plate and a part of one widthwise side of the third conductor plate and that is arranged at an angle of about 90° with respect to the first conductor plate and the third conductor plate.

It is preferable to configure the antenna element, wherein a defect is provided in a part of a side of at least the sixth conductor plate or the seventh conductor plate extending from the fourth conductor plate.

It is preferable to configure the antenna element, further comprising a fifth conductor plate that is arranged at a position opposing the fourth conductor plate with the first conductor plate and the third conductor plate sandwiched between the fourth and fifth conductor plates and that shares the one side of the first conductor plate and the one side of the third conductor plate.

It is preferable to configure the antenna element, wherein the sixth conductor plate or the seventh conductor plate is formed from an elongated line into a meandering shape.

It is preferable to configure the antenna element, wherein a space defined by the first conductor plate, the third conductor plate, and the fourth conductor plate is filled with a dielectric material or a magnetic material.

An antenna element according to the present invention is configured by comprising: a substantially rectangular second conductor plate arranged at a predetermined space from a ground plate; a fourth conductor plate that shares one side of the first conductor plate apart from a feeding point on the first conductor plate where electric power is fed from the ground plate and that is arranged at an angle of about 90° with respect to the first conductor plate; and a sixth conductor plate, a seventh conductor plate, and an eighth conductor plate that extend from three sides of the fourth conductor plate which do not share one side of the first conductor plate and that are arranged at an angle of about 90° with respect to the fourth conductor plate, wherein the sixth conductor plate, the seventh conductor plate, and the eighth conductor plate share respective adjoining sides, to thus form a C-shaped folded portion.

It is preferable to configure the antenna element, further comprising: a first conductor plate that shares one widthwise side of the second conductor plate proximate to the feeding point and that is arranged at an angle of about 90° with respect to the second conductor plate; and a third conductor plate that shares another widthwise side of the second conductor plate opposing the side of the second conductor plate shared by the first conductor plate and that is disposed at an angle of about 90° so as to oppose the first conductor plate.

It is preferable to configure the antenna element, wherein a defect is formed in a part of a side of at least one of the sixth conductor plate, the seventh conductor plate, and the eighth conductor plate extending from the fourth conductor plate.

It is preferable to configure the antenna element, further comprising a fifth conductor plate that is arranged at a position opposing the fourth conductor plate with the first conductor plate sandwiched between the fourth and fifth conductor plates and that shares the one side of the first conductor plate.

It is preferable to configure the antenna element, wherein the sixth conductor plate, the seventh conductor plate, or the eighth conductor plate is formed from an elongated line into a meandering shape.

It is preferable to configure the antenna element, wherein a space defined by the second conductor plate, the fourth conductor plate, the sixth conductor plate, the seventh conductor plate, and the eighth conductor plate is filled with a dielectric material or a magnetic material.

### ADVANTAGES OF THE INVENTION

According to the present invention, an antenna element includes: a first conductor plate arranged at a predetermined space from a ground plate; a second conductor plate sharing one widthwise side of the first conductor plate; and a third conductor plate that shares one widthwise side of the second conductor plate opposing one side of the second conductor plate shared by the first conductor plate, wherein a rectangular parallelepiped antenna element is made by folding a board-shaped monopole antenna element into two faces or more. The antenna element can accomplish a broader band than does a cubic antenna element having the same volume, and a compact, broadband antenna can be implemented. Moreover, electric power is fed from a substantial corner of the ground plate to a substantial corner of the rectangular parallelepiped antenna element, so that a multi-band antenna that effects resonance at various frequency bands can be implemented.

Further, according to the present invention, in a foldable radio having a hinge, an antenna element is disposed in a vicinity of the hinge, whereby high antenna gain can be yielded over a broad range regardless of whether or not the portable radio is closed or opened. Hence, there can be provided a compact portable radio that can implement multi-band communication.

### BRIEF DESCRIPTION OF THE DRAWINGS

FIG. 1 is a perspective view showing a portable radio of a first embodiment of the present invention in a closed state.

FIG. 2 is a perspective view showing a portable radio terminal of the first embodiment in an open state.

FIG. 3 is a graph showing a VSWR characteristic acquired when the portable radio of the first embodiment is closed.

FIG. 4 is a graph showing a VSWR characteristic acquired when the portable radio of the first embodiment is open.

FIG. 5 is a perspective view showing a portable radio of a second embodiment of the present invention in a closed state.

FIG. 6 is a graph showing a VSWR characteristic acquired when the portable radio of the second embodiment is closed.

FIG. 7 is a perspective view of an antenna element of a board-shaped monopole antenna.

FIG. 8 is a perspective view of an antenna element of a box-shaped monopole antenna.

FIG. 9 is a graph showing a VSWR characteristic of an antenna element of the board-shaped monopole antenna.

FIG. 10 is a graph showing a VSWR characteristic of an antenna element of the box-shaped monopole antenna.

FIG. 11 is a perspective view showing an antenna element of a third embodiment.

FIG. 12 is a graph showing a VSWR characteristic of the antenna element of the third embodiment.

FIG. 13 is a perspective view showing an antenna element of another form.

FIG. 14 is a graph showing a VSWR characteristic of the antenna element shown in FIG. 13.

FIG. 15 shows a cross sectional profile of a box-shaped antenna element of a first antenna element.

FIG. 16 is a perspective view showing a modification of the antenna element of the third embodiment.

FIG. 17 is a perspective view showing a modification of the antenna element of the third embodiment.

FIG. 18 is a perspective view showing an antenna element of a fourth embodiment.

FIG. 19 is a graph showing a VSWR characteristic of the antenna element of the fourth embodiment.

FIG. 20 is a perspective view showing a modification of the antenna element of the fourth embodiment.

FIG. 21 is a perspective view showing a modification of the antenna element of the fourth embodiment.

FIG. 22 is a perspective view showing an antenna element of a fifth embodiment.

FIG. 23 is a graph showing a VSWR characteristic of the antenna element of the fifth embodiment.

FIG. 24 is a perspective view showing a modification of the antenna element of the fifth embodiment.

FIG. 25 is a perspective view showing a modification of the antenna element of the fifth embodiment.

FIG. 26 is a perspective view showing an antenna element of a sixth embodiment.

FIG. 27 is a graph showing a VSWR characteristic of the antenna element of the sixth embodiment.

FIG. 28 is a perspective view showing a modification of the antenna element of the sixth embodiment.

FIG. 29 is a perspective view showing a modification of the antenna element of the sixth embodiment.

FIG. 30 is a perspective view showing an antenna element of a seventh embodiment.

FIG. 31 is a graph showing a VSWR characteristic of the antenna element of the seventh embodiment.

FIG. 32 is a perspective view showing a modification of the antenna element of the seventh embodiment.

FIG. 33 is a perspective view showing a modification of the antenna element of the seventh embodiment.

FIG. 34 is a perspective view showing the antenna element of the seventh embodiment having defects.

FIG. 35 shows that a second antenna of the antenna element of the third embodiment shown in FIG. 18 has a meandering structure.

FIG. 36 is a perspective view showing an antenna element of an eighth embodiment.

FIG. 37 is a graph showing a VSWR characteristic of the antenna element of the eighth embodiment.

FIG. 38 is a perspective view showing a modification of the antenna element of the eighth embodiment.

FIG. 39 is a perspective view showing a modification of the antenna element of the eighth embodiment.

FIG. 40 is a perspective view of a principal block of another related art antenna element.

In FIG. 41, (A) is a perspective view showing still another related art antenna element, and (B) is a side view of the antenna element.

### DESCRIPTIONS OF THE REFERENCE NUMERALS AND SYMBOLS

10, 20 PORTABLE RADIO
2 LOWER HOUSING (FIRST HOUSING)
21 LOWER CIRCUIT BOARD (GROUND PLATE)
22 FIRST RADIO CIRCUIT
23 SECOND RADIO CIRCUIT
24 THIRD RADIO CIRCUIT
25 FOURTH RADIO CIRCUIT
26 DUPLEXER
27 MATCHING CIRCUIT
3 UPPER HOUSING (SECOND HOUSING)
31 UPPER CIRCUIT BOARD
4 HINGE
5 ANTENNA ELEMENT
51 FIRST CONDUCTOR PLATE
52 SECOND CONDUCTOR PLATE
53 THIRD CONDUCTOR PLATE
54 FOURTH CONDUCTOR PLATE
55 FIFTH CONDUCTOR PLATE
56, 56′ SIXTH CONDUCTOR PLATE
57, 57′ SEVENTH CONDUCTOR PLATE
58 EIGHTH CONDUCTOR PLATE
61 POWER FEEDING CONDUCTOR
65 PARALLEL RESONANCE CIRCUIT
70, 71, 72 FOURTH ANTENNA ELEMENT

### BEST MODES FOR IMPLEMENTING THE INVENTION

Embodiments of the present invention are hereunder described in detail by reference to the accompanying drawings.

### First Embodiment

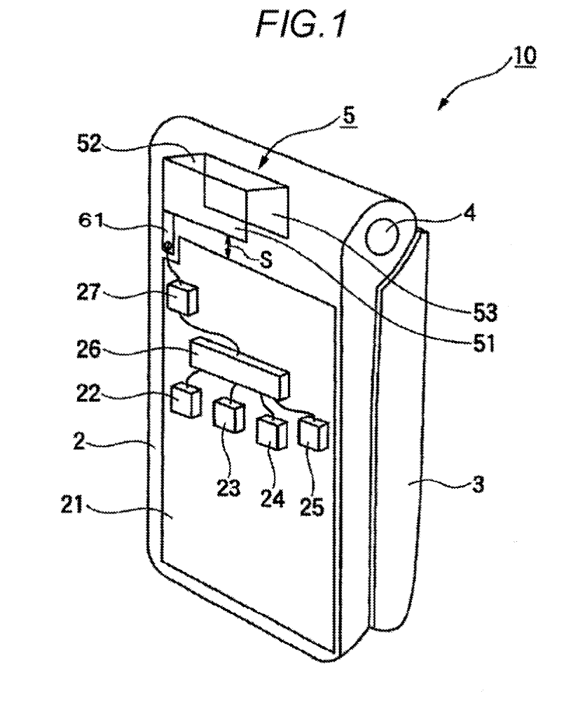

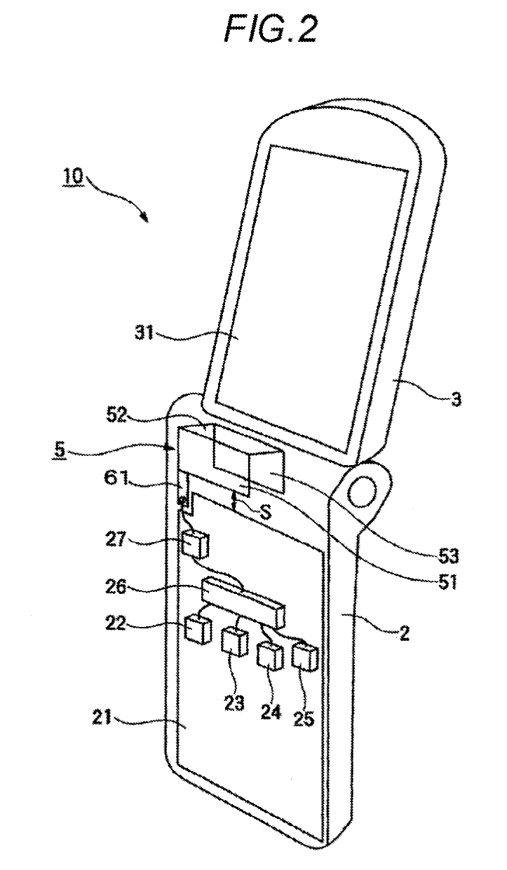

FIGS. 1 and 2 show a foldable portable radio 10 of a first embodiment of the present invention. The portable radio 10 includes a lower housing 2 that is a first housing; an upper housing 3 that is a second housing; a hinge 4 that rotatably couples the lower housing 2 to the upper housing 3; and an antenna element 5 configuring a monopole antenna.

The lower housing 2 accommodates a lower circuit board 21 configuring a ground plate of the portable radio 10 and is configured so as to feed electric power from a corner of the ground plate to the antenna element 5. The lower housing 2 of the present embodiment is made up of a resin frame.

Mounted on the lower circuit board 21 are a first radio circuit 22, a second radio circuit 23, a third radio circuit 24, a fourth radio circuit 25, a duplexer 26, and a matching circuit 27. In the embodiment, the lower circuit board is formed to a size of; for instance, 45×85 mm.

In the present embodiment, the first radio circuit 22 is compatible with a frequency band of 1.5 GHz; the second radio circuit 23 is compatible with 1.7 GHz band; the third radio circuit 24 is compatible with 2 GHz band; and the fourth radio circuit 25 is compatible with 2.4 GHz band.

The duplexer 26 is for duplexing an antenna among a plurality of radio frequency bands. In the present embodiment, for instance, bandpass filters are provided for the respective frequency bands in a one-to-one correspondence.

The matching circuit 27 is for carrying out a function of matching the antenna element 5 with circuit impedance (generally, 50Ω).

The upper housing 3 accommodates an upper circuit board 31.

When the upper and lower housings are opened, the upper circuit board 31 and the antenna element 5 are coupled together by means of capacitive coupling, thereby operating as a hosing antenna (as a composite antenna). The upper housing 3 of the present embodiment is also formed from a resin frame, as is the lower housing 2. In the present embodiment, the upper circuit board 31 is made to a size of for instance, 45×75 mm.

The antenna element 5 is placed in the proximity of the hinge. The antenna element 5 has a first conductor plate 51, a second conductor plate 52, a third conductor plate 53, and a feed conductor 61 and is configured such that electric power is fed from a corner of the ground plate to the first conductor plate 51 by way of the feed conductor 61. In relation; in particular, to power feed of the present embodiment, electric power is fed from a substantial corner of the lower circuit board 21 to a similar substantial corner of the first conductor plate 51 by way of the feed conductor 61. Each of the conductor plates 51 to 53 of the present embodiment has a thickness of; for instance, 0.1 mm. In relation to specific sizes of the first conductor plate 51 to the third conductor plate 53 of the present embodiment; for instance, the first conductor plate 51 measures 22×6 mm; the second conductor plate 52 measures 22×5 mm; and the third conductor plate 53 measures 22×6 mm.

In the present embodiment, in order to fasten the antenna element 5, the antenna element is secured by means of; for instance, an insulative holder that exhibits a low dielectric constant.

The first conductor plate 51 is made up of a substantially rectangular plate placed in proximity to the hinge 4 and at a predetermined space away from the ground plate; and is connected to the matching circuit 27 on the ground plate by way of the feed conductor 61. The first conductor plate 51 and the second conductor plate 52 are arranged to share a long side while bent at an angle of about 90°.

The first conductor plate 51 is a substantially rectangular, thin conductor and connected to the duplexer 26 by way of the matching circuit 27. The duplexer 26 is connected respectively to the first radio circuit 22 to the fourth radio circuit 25 that make up radio blocks of individual communications systems.

The second conductor plate 52 is likewise made up of a substantially rectangular, thin conductor that shares one widthwise side of the first conductor plate 51 and that is arranged while bent at an angle of about 90° with respect to (a direction of a plane of) the first conductor plate 51. The second conductor plate 52 and the third conductor plate 53 are arranged so as to share one widthwise side (a long side) while bent at an angle of about 90° with respect to each other. Therefore, the first conductor plate 51 and the third conductor plate 53 oppose each other.

The third conductor plate 53 is likewise a substantially rectangular, thin conductor and shares one side that is not shared by the first conductor plate 51, among the two widthwise sides (long sides) of the second conductor plate 52. The third conductor plate 53 is made up of a substantially rectangle that is arranged so as to oppose the first conductor plate 51 while bent at an angle of about 90° with respect to the second conductor plate 52. In the present embodiment, a space S from the first conductor plate 51 and the third conductor plate 53 to the lower circuit board 21 is; for instance, about 5 mm.

Operation of the embodiment is now described.

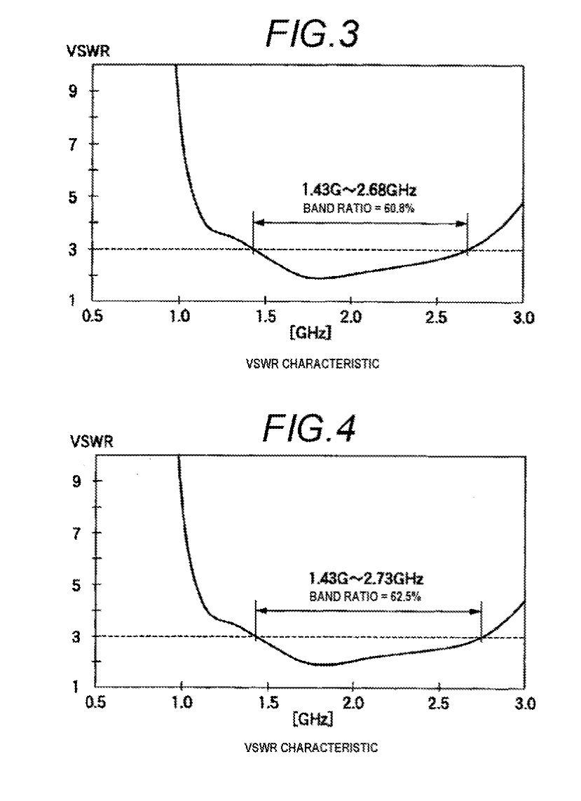

FIGS. 3 and 4 are graphs showing VSWR characteristics of the upper and lower housings 2, 3 acquired when they are closed and opened. In the present invention, a frequency range where VSWR≦3 can be satisfied is defined as a bandwidth (an operating frequency band). A horizontal axis represents a frequency, and a vertical axis represents a voltage standing wave ratio (hereinafter abbreviated as a “VSWR”).

Examination of a band ratio (a ratio of bandwidth to a center frequency) acquired at the time of closing of the housings and a band ratio acquired at the time of opening of the housings provides results, such as those provided below.

Specifically, in the present embodiment, when the housings are closed, a frequency band satisfying a condition of VSWR≦3 ranges from 1.43 GHz to 2.68 GHz (a center frequency: 2.055 GHz and a bandwidth: 1.25 GHz), and a band ratio is 60.8%.

In the meantime, in the present embodiment, when the housings are opened, a frequency band satisfying a condition of VSWR≦3 ranges from 1.43 GHz to 2.73 GHz (a center frequency: 2.08 GHz and a bandwidth: 1.3 GHz), and a band ratio is 62.5%.

The principle of the antenna element 5 of the present embodiment is now described.

(i) Principle of a broad frequency band:

a) Power is fed to the corner (the angular portion) of the first conductor plate 51 (the rectangular, board-shaped conductor plate), whereupon resonance takes place in various frequency bands, so that a multi-band antenna is implemented. Specifically, the reason for this is that the antenna becomes able to cover frequency bands from a low frequency band as a result of electric power being fed not the center but the corner (angular portion) of the first conductor plate 51 (the board-shaped conductor plate).

b) Likewise, in relation to power feed from the lower circuit board 21 that is the ground plate, since distribution of an antenna current appears also in the ground plate because the length of the element is a half wavelength or less. Therefore, it is better to feed electric power from the corner (angular portion) of the lower circuit board 21 (the ground plate) than from the center of the same, from the viewpoint of suitableness for implementation of a multi-band antenna that covers frequency bands from a low frequency band. A compact, multi-band antenna can thereby be implemented.

c) In relation to the three-dimensional shape of the antenna element 5, a rectangular parallelepiped (each of the conductor plates assumes a rectangular shape) implements a broader band than does a cube (each of the conductor plates assumes a square shape) on the assumption that they have the same volume as in the embodiment. The reason for this is that the number of resonance frequency bands increases because the shape is not symmetrical.

(ii) A horizontal to vertical ratio (an aspect ratio) of the conductor plate that accomplishes a broader frequency band:

a) Although the first conductor plate 51 (the board-shaped conductor plate) preferably assumes a rectangular shape (a rectangular shape), the essential requirement is that a ratio of a vertical side to a horizontal side (an aspect ratio) of the first conductor plate be 20% or more (especially, it is better that a side opposing a widthwise direction of the lower circuit board 21 (a circuit board) become longer than sides orthogonal to the opposing side).

b) Operation of the antenna element when the upper and lower housings are opened: The upper circuit board 31 of the upper housing 3 and the second conductor plate (a board-shaped conductor plate) 52 or the third conductor plate (a board-shaped conductor plate) 53 of the lower housing 2 are coupled together by means of capacitive coupling, whereby the upper circuit board 31 is excited, to thus operate as an antenna (a first antenna). As a consequence, since the volume of the antenna becomes larger, the band can be made broader than that achieved when the upper and lower housings are closed. An antenna gain that is higher than that achieved when the upper and lower housings are closed is implemented in particularly a low frequency band.

Therefore, according to the present embodiment, electric power is fed from the corner of the lower circuit board 21 that is the ground plate to the corner of the first conductor plate 51 (the board-shaped conductor plate), whereby a superior antenna characteristic can be acquired from a low frequency band despite a compact antenna.

According to the present embodiment, the antenna element 5 that is a box-shaped antenna is arranged in the vicinity of the hinge 4 of the foldable portable radio 10, whereby the structure of the portable radio 10 can be made compact. Further, a high communication gain and frequency bands for a plurality of communication systems can be acquired. Moreover, a high communication gain can be acquired regardless of whether the lower housing 2 that is the first housing and the upper housing 3 that is the second housing are opened or closed.

### Second Embodiment

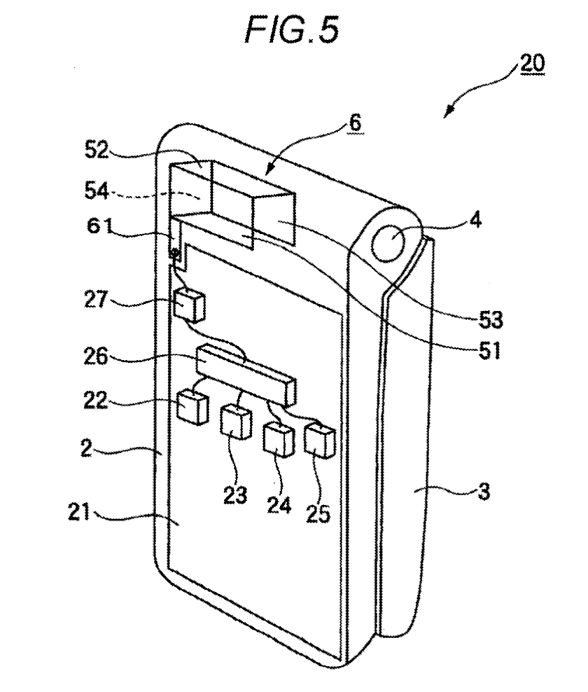

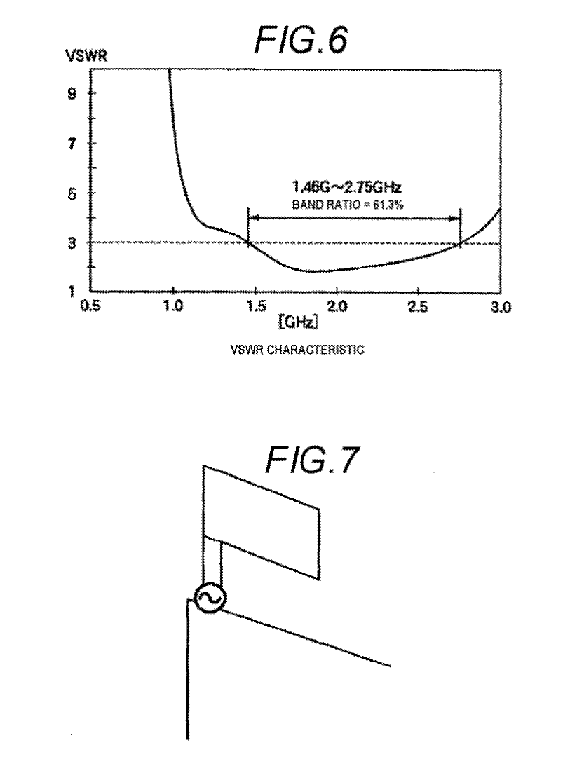

A second embodiment of the present invention is now described by reference to FIGS. 5 and 6. In the present embodiment, elements that are the same as those described in connection with the first embodiment are assigned the same reference numerals, and their repeated explanations are omitted.

FIG. 5 shows a portable radio 20 of the present embodiment. The portable radio 20 differs from the portable radio 10 of the first embodiment in that an antenna element 6 configuring the first antenna has a fourth conductor plate 54 as well as the first conductor plate 51 to the third conductor plate 53.

The fourth conductor plate 54 is a substantially rectangular, thin conductor plate as are the other conductor plates and shares (a total of three sides) one side of the first conductor plate 51, one side of the second conductor plate 52, and one side of the third conductor plate 53. In the present embodiment, the fourth conductor plate 54 is provided on the same end face where the feed conductor 61 is provided. The fourth conductor plate 54 of the present embodiment measures 5×6 mm. Even in the present embodiment, the antenna element 6 is secured by means of; for instance, an insulative holder exhibiting a low dielectric constant, as in the case of the first embodiment.

FIG. 6 is a graph showing a VSWR characteristic acquired when the housings are closed. Even in connection with FIG. 6, a frequency range where a condition of VSWR≦3 can be satisfied is defined as a band width (an operating frequency band).

According to the graph shown in FIG. 6, when the housings are closed, a frequency band satisfying a condition of VSWR≦3 ranges from 1.46 GHz to 2.75 GHz (a center frequency: 2.105 GHz and a bandwidth: 1.29 GHz), and a band ratio is 61.3%.

Therefore, according to the present embodiment, the band ratio of the antenna element 6 of the present embodiment acquired when the housings are closed is 61.3% when compared with the case where the band ratio of the antenna element 5 of the first embodiment is 60.8%. Therefore, even though there is a little increase, the band of the antenna element can be made broader than the band of the antenna element 5 of the first embodiment. Thus, since the band of the antenna element can be made broader, the antenna can be made much smaller according to desired frequency bands.

### Third Embodiment

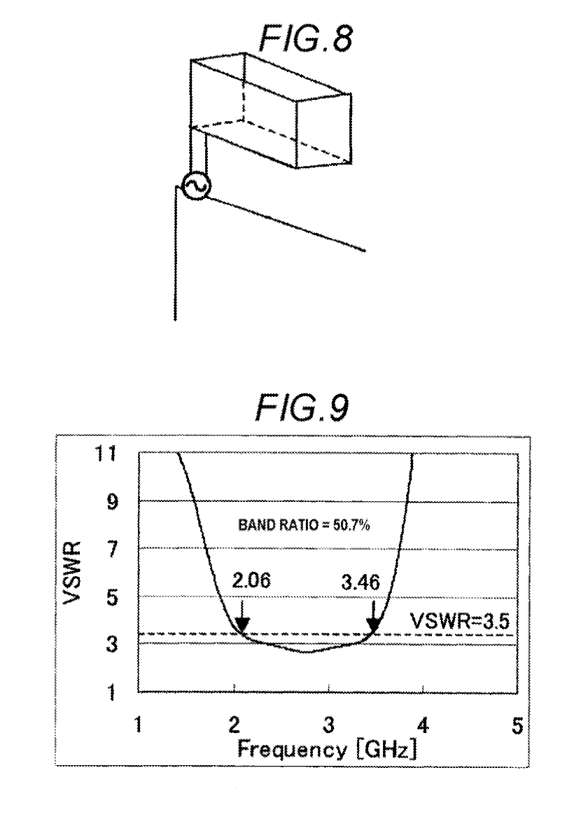

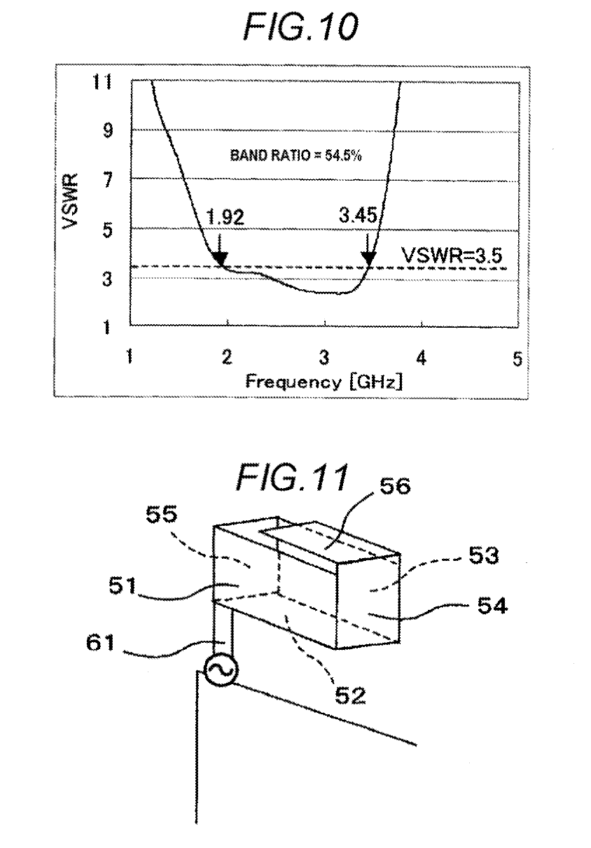

An antenna element shown in FIG. 7 that is a board-shaped monopole antenna having a thickness of 0.5 mm is compared with an antenna element shown in FIG. 8 that is a box-shaped monopole antenna which makes up a pentahedron whose top is not provided with a conductor plate and that has an exterior thickness of 2.0 mm. FIG. 9 is a graph showing a VSWR characteristic of an antenna element of the board-shaped monopole antenna. FIG. 10 is a graph showing a VSWR characteristic of an antenna element of the box-shaped monopole antenna.

As shown in FIG. 9, when the antenna element is a board-shaped monopole antenna, a frequency band satisfying VSWR≦3.5 is 2.06 GHz to 3.46 GHz, and a band ratio is about 50.7%. Meanwhile, as shown in FIG. 10, when the antenna element is a box-shaped monopole antenna, a frequency band satisfying VSWR≦3.5 is 1.92 GHz to 3.45 GHz, and a band ratio is about 54.5%. Thus, band broadening effects can be expected by imparting a pentahedral box shape to the antenna element. However, the box-shaped antenna element does not yield any special advantages in terms of a mounting area.

The antenna element of the third embodiment differing from the previously-described board-shaped antenna element or the pentahedral box-shaped antenna element is hereunder described. FIG. 11 is a perspective view showing the antenna element of the third embodiment. As shown in FIG. 11, the antenna element of the third embodiment comprises the first conductor plate 51, the second conductor plate 52, the third conductor plate 53, the fourth conductor plate 54, a fifth conductor plate 55, a sixth conductor plate 56, and the feed conductor 61. The antenna element is also configured so as to feed electric power from the corner of the ground plate to the first conductor plate 51 by way of the feed conductor 61, as in the case of the first or second embodiment.

The first conductor plate 51 is a substantially rectangular, thin conductor arranged at a predetermined space away from the ground plate and has a long side measuring; for example, 24 mm, and a short side measuring; for example, 5 mm. The first conductor plate 51 and the second conductor plate 52 share one widthwise side (long side) and are placed while bent at an angle of about 90° with respect to each other. The second conductor plate 52 is a substantially rectangular, thin conductor; shares one widthwise side of the first conductor plate 51; and is placed while bent at an angle of about 90° with respect to (the direction of the plane of) the first conductor plate 51.

The third conductor plate 53 is a substantially rectangular, thin conductor; shares one of the two widthwise sides (long sides) of the second conductor plate 52 that is not shared by the first conductor plate 51; and is arranged while bent at an angle of about 90°. The third conductor plate 53 is arranged so as to oppose the first conductor plate 51 while bent at an angle of about 90° with respect to the second conductor plate 52.

The fourth conductor plate 54 is a substantially rectangular, thin conductor. Respective sides (three sides) of the fourth conductor plate 54 share one side (a short side) of the first conductor plate 51, one side (a short side) of the second conductor plate 52, and one side (a short side) of the third conductor plate 53. The fourth conductor plate 54 is arranged at an end face apart from the feed conductor 61.

The fifth conductor plate 55 is a substantially rectangular, thin conductor. Respective sides (three sides) of the fifth conductor plate 55 share one side (a short side) of the first conductor plate 51, one side (a short side) of the second conductor plate 52, and one side (a short side) of the third conductor plate 53. The fifth conductor plate 55 is arranged at an end face apart from the feed conductor 61.

The sixth conductor plate 56 is a substantially rectangular, thin conductor; extends from one side of the fourth conductor plate 54 that shares neither the one side of the first conductor plate 51, the one side of the second conductor plate 52, nor the one side of the third conductor plate 53; and is placed while bent at an angle of about 90° with respect to the fourth conductor plate 54. Both side ends of the sixth conductor plate 56 are coupled to neither the first conductor plate 51 nor the third conductor plate 53. Slit-shaped clearance (hereinafter called a “slit”) exists between the sixth conductor plate 56 and the first conductor plate 51 and between the same and the third conductor plate 53. In addition, an opposite end of the sixth conductor plate 56 with respect to its end coupled to the fourth conductor plate 54 is not coupled to the fifth conductor plate 55, either.

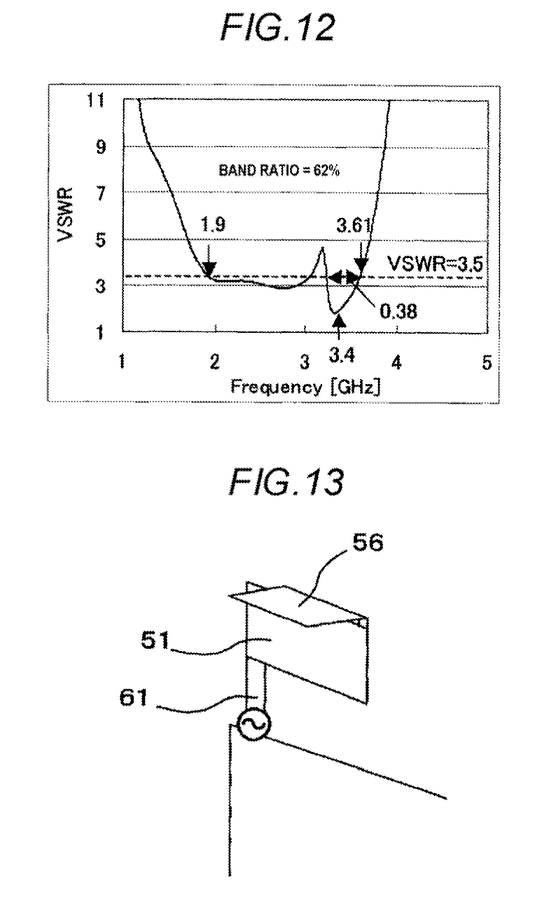

A pentahedron made up of the first conductor plate 51 to the fifth conductor plate 55 is taken as a first antenna element, and the sixth conductor plate 56 is taken as a second antenna element. At this time, the first antenna element yields a broadband characteristic exhibiting a variety of current distributions, and the second antenna element effects resonance at a specific band. FIG. 12 is a graph showing a VSWR characteristic of the antenna element of the third embodiment. As shown in FIG. 12, the second antenna element effects resonance at a band of about 3.4 GHz differing from a resonance frequency of the first antenna element. A resonance frequency of the second antenna element; however, changes according to the length of the sixth conductor plate 56 extending from the fourth conductor plate 54.

As shown in FIG. 12, the frequency band of the antenna element of the third embodiment satisfying VSWR≦3.5 somewhat includes a characteristic deterioration band stemming from a barely-existing counter-resonance block but approximately ranges from 1.9 GHz to 3.61 GHz, and a band ratio is about 62%. The sixth conductor plate 56 having a length of 16.1 mm has a frequency band of about 4.5 GHz and measures λ/4. However, as mentioned above, a slit exists between the sixth conductor plate 56 and the first conductor plate 51 and between the sixth conductor plate 56 and the third conductor plate 53. As a result of a capacitive component existing between the second antenna element and the first antenna element, the resonance frequency of the second antenna element becomes lower by an amount of about 1 GHz, whereby a band of about 0.38 GHz is obtained around 3.4 GHz. A width of the slit is of the order of 0.02λ or less with reference to the resonance frequency λ of the second antenna element; for instance, about 0.5 mm.

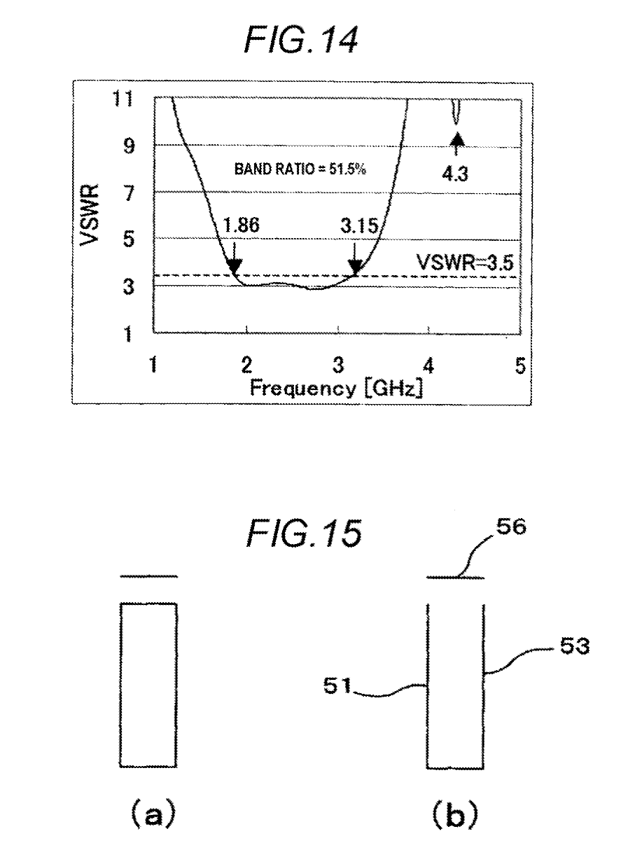

FIG. 13 shows an analogous shape of an antenna element that is equipped with a simple folded element differing from the element of the present embodiment and that is formed with the same amount of projection. The first antenna element is made up of only the first conductor plate 51, and a slit exists between the sixth conductor plate 56 configuring the second antenna element and the first conductor plate 51. FIG. 14 is a graph showing a VSWR characteristic of the antenna element shown in FIG. 13. As shown in FIG. 14, since the second antenna element effects slight resonance at 4.3 GHz, it is desirable that the first antenna element should assume a box shape rather than a board shape.

Even in a case where the first antenna element assumes a box shape, if a surface of the second antenna element and a surface of the first antenna element oppose each other as shown by (a) in FIG. 15, electric currents will flow in opposite phases through the respective opposing surfaces, which will in turn obstruct radiation originating from the second antenna element. On the contrary, in the embodiment, the surface of the second antenna element does not contact the surface of the first antenna element, and a slit exists between the second antenna element and the first antenna element, as shown by (b) in FIG. 15. Since the slit is provided with an appropriate capacitive component, there is expected a double effect of being capable of increasing an electrical length of the second antenna element and lessening an adverse effect of an electric current of opposite phase on radiation.

As mentioned above, according to the present embodiment, the first antenna element and the second antenna element have different resonance frequency bands, respectively. The resonance frequency can be controlled by adjusting the length of the sixth conductor plate 56 configuring the second antenna element. Therefore, there can be provided an antenna element compatible with a broader frequency band and multiple bands.

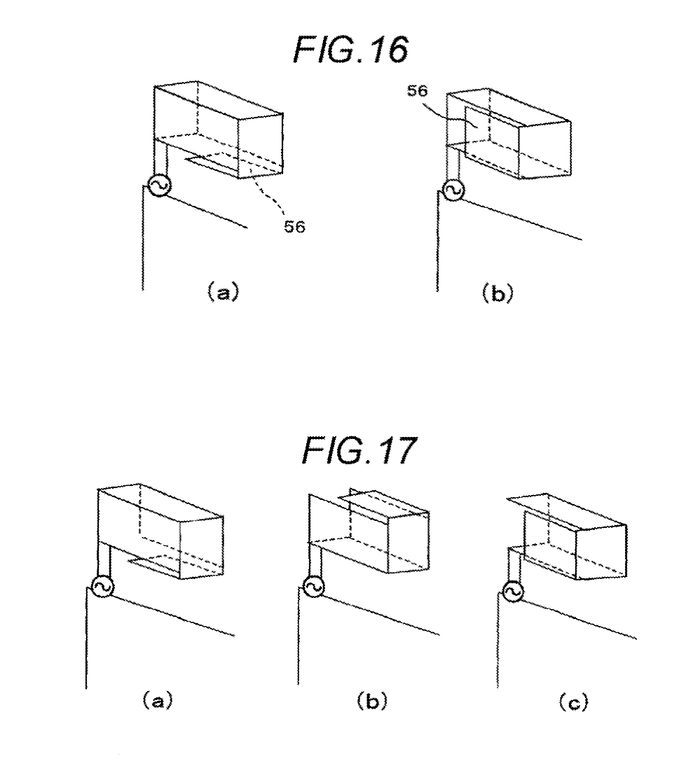

The first antenna element is not limited to a polyhedral box shape having an open top. As shown in FIG. 16, the first antenna element may also assume a shape having an open lower surface or an open side surface. In this case, the sixth conductor plate 56 extends from the fourth conductor plate 54 to an open surface side. Moreover, as shown in FIG. 17, the fifth conductor plate 55 does not always need to be provided.

### Fourth Embodiment

An antenna element of a fourth embodiment is now described. Of constituent elements configuring the antenna element of the fourth embodiment, elements that are the same as those of the antenna element described in connection with the third embodiment are assigned the same reference numerals, and their repeated descriptions are omitted here for brevity.

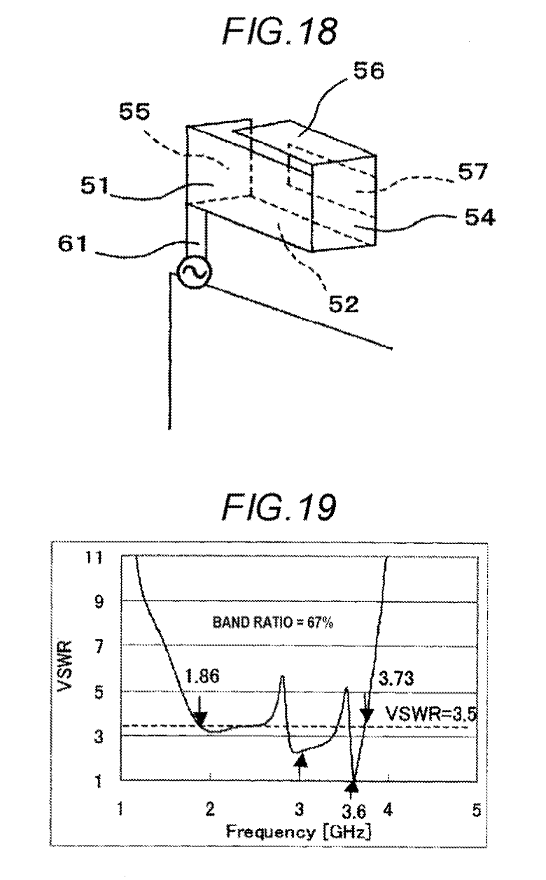

FIG. 18 is a perspective view showing the antenna element of the fourth embodiment. As shown in FIG. 18, the antenna element of the fourth embodiment has the first conductor plate 51; the second conductor plate 52; the fourth conductor plate 54; the fifth conductor plate 55; the sixth conductor plate 56; a seventh conductor plate 57; and the feed conductor 61.

The seventh conductor plate 57 is a substantially rectangular, thin conductor; extends from one of two sides adjoining the fourth conductor plate 54 that share neither the one side of the first conductor plate 51 nor the one side of the second conductor plate 52; and is placed while bent at an angle of about 90° with respect to the fourth conductor plate 54. Both side ends of the seventh conductor plate 57 are coupled to neither the second conductor plate 52 nor the sixth conductor plate 56. Slit-shaped clearance (hereinafter called a “slit”) exists between the sixth conductor plate 56 and the first conductor plate 51, between the sixth conductor plate 56 and the seventh conductor plate 57, and between the seventh conductor plate 57 and the second conductor plate 52. An opposite end of the seventh conductor plate 57 with respect to the fourth conductor plate 54 is not coupled to the fifth conductor plate 55, either.

In the embodiment, the first antenna element is made up of the first conductor plate 51, the second conductor plate 52, the fourth conductor plate 54, and the fifth conductor plate 55. The second antenna element is made up of the sixth conductor plate 56. The third antenna element is made up of the seventh conductor plate 57. In the antenna elements of the present embodiment, the first antenna element has a broadband characteristic exhibiting a variety of current distributions. The second antenna element and the third antenna element effect resonance at respective different specific bands.

FIG. 19 is a graph showing a VSWR characteristic of the antenna element of the fourth embodiment. As shown in FIG. 19, the second antenna element effects resonance at a band of about 3.0 GHz differing from the resonance frequency of the first antenna element and the third antenna element. The third antenna element effects resonance at a band in the vicinity of 3.6 GHz that differs from the resonance frequency of the first antenna element and the resonance frequency of the second antenna element. However, the resonance frequency of the second antenna element and the resonance frequency of the third antenna element change according to the length of the sixth conductor plate 56 extending from the fourth conductor plate 54 and the length of the seventh conductor plate 57 extending from the fourth conductor plate 54. The frequency band satisfying VSWR≦3.5 somewhat includes the characteristic deterioration band stemming from the counter-resonance block and approximately ranges from 1.86 GHz to 3.73 GHz. A band ratio of the frequency band exhibits a broadband characteristic of about 67%.

According to the present embodiment, the first antenna element, the second antenna element, and the third antenna element each have different resonance frequency bands. The resonance frequency can be controlled by adjusting the length of the sixth conductor plate 56 configuring the second antenna element and the length of the seventh conductor plate 57 configuring the third antenna element. Therefore, there can be provided antenna elements compatible with a broader frequency band and multiple bands.

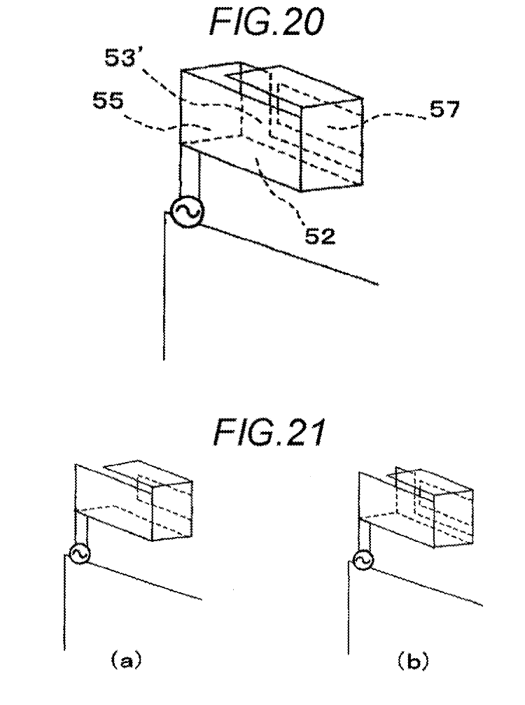

As shown in FIG. 20, an L-shaped conductor plate 53′ connected to the second conductor plate 52 and the fifth conductor plate 55 can also be interposed among the seventh conductor plate 57, the second conductor plate 52, and the fifth conductor plate 55 with a slit between the conductor plate 53′ and the seventh conductor plate 57. As shown in FIG. 21, there is no necessity to place the fifth conductor plate 55.

### Fifth Embodiment

An antenna element of a fifth embodiment is now described. Of constituent elements configuring the antenna element of the fifth embodiment, constituent elements that are the same as those of the antenna element described in connection with the third embodiment are assigned the same reference numerals, and their repeated explanations are omitted here for brevity.

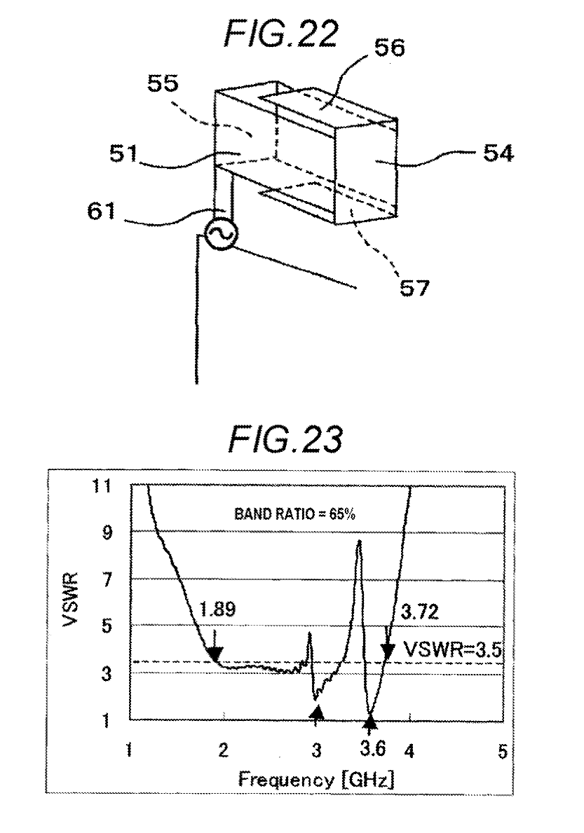

FIG. 22 is a perspective view showing the antenna element of the fifth embodiment. As shown in FIG. 22, the antenna element of the fifth embodiment includes the first conductor plate 51, the third conductor plate 53, the fourth conductor plate 54, the fifth conductor plate 55, the sixth conductor plate 56, the seventh conductor plate 57, and the feed conductor 61.

The seventh conductor plate 57 is a substantially rectangular, thin conductor; extends from one of mutually-opposing sides of the fourth conductor plate 54 that shares neither the one side of the first conductor plate 51 nor the one side of the second conductor plate 52; and is placed while bent at an angle of about 90° with respect to the fourth conductor plate 54. Both side ends of the seventh conductor plate 57 are coupled to neither the first conductor plate 51 nor the third conductor plate 53, and slit-shaped clearance (hereinafter called a “slit”) exists between the seventh conductor plate 57, the first conductor plate 51, and the third conductor plate 53. An opposite end of the seventh conductor plate 57 with respect to the fourth conductor plate 54 is not coupled to the fifth conductor plate 55, either.

In the embodiment, the first antenna element includes the first conductor plate 51, the third conductor plate 53, the fourth conductor plate 54, and the fifth conductor plate 55. The second antenna element includes the sixth conductor plate 56. The third antenna element includes the seventh conductor plate 57. In the first antenna element of the present embodiment, the first antenna element has a broadband characteristic exhibiting a variety of current distributions, and the second antenna element and the third antenna element effect resonance at respective different specific bands.

FIG. 23 is a graph showing a VSWR characteristic of the antenna element of the fifth embodiment. As shown in FIG. 23, the second antenna element effects resonance at a band of about 3.0 GHz differing from the resonance frequency of the first antenna element and that of the third antenna element. The third antenna element effects resonance at a band of about 3.6 GHz differing from the resonance frequency of the first antenna element and that of the second antenna element. The resonance frequency of the second antenna element and the resonance frequency of the third antenna element vary according to the length of the sixth conductor plate 56 extending from the fourth conductor plate 54 and the length of the seventh conductor plate 57 extending from the fourth conductor plate 54. The frequency band satisfying VSWR≦3.5 somewhat includes the characteristic deterioration band stemming from the counter-resonance block but generally ranges from 1.89 GHz to 3.72 GHz. A band ratio is about 65%, which exhibits a broadband characteristic.

According to the present embodiment, the first antenna element, the second antenna element, and the third antenna element each exhibit different resonance frequency bands. The resonance frequency can be controlled by adjusting the length of the sixth conductor plate 56 configuring the second antenna element and the length of the seventh conductor plate 57 configuring the third antenna element. Therefore, there can be provided an antenna element compatible with a broader frequency band and multiple bands.

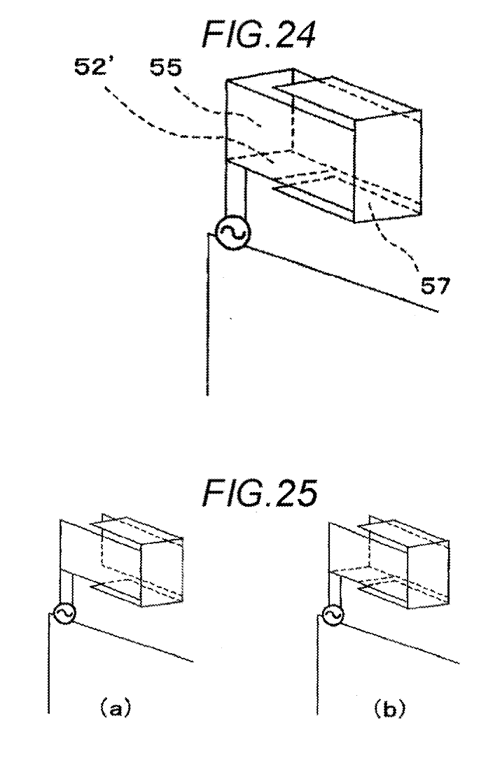

As shown in FIG. 24, a rectangular conductor plate 52′ connected to the fifth conductor plate 55 can also be interposed between the seventh conductor plate 57 and the fifth conductor plate 55 with a slit existing between the conductor plate 52′ and the seventh conductor plate 57. As shown in FIG. 25, the fifth conductor plate 55 does not always need to be provided.

### Sixth Embodiment

An antenna element of a sixth embodiment is described. Of constituent elements configuring the antenna element of the sixth embodiment, constituent elements that are the same as those of the antenna element described in connection with the third embodiment are assigned the same reference numerals, and their repeated explanations are omitted here for brevity.

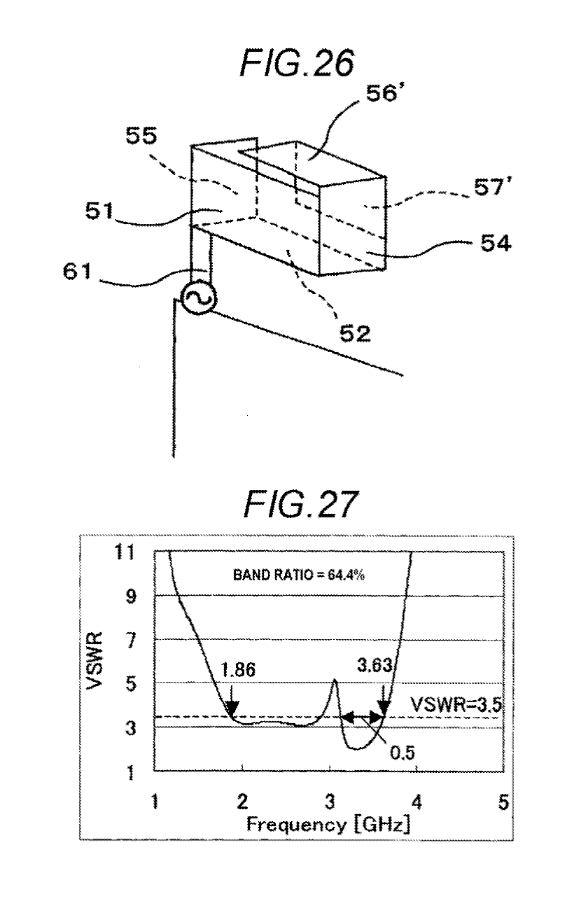

FIG. 26 is a perspective view showing the antenna element of the sixth embodiment. As shown in FIG. 26, the antenna element of the sixth embodiment includes the first conductor plate 51, the second conductor plate 52, the fourth conductor plate 54, the fifth conductor plate 55, a sixth conductor plate 56′, a seventh conductor plate 57′, and the feed conductor 61.

The sixth conductor plate 56′ and the seventh conductor plate 57′ each are made of substantially rectangular, thin conductors and make up a second antenna element that share a long side and that assume an L-shaped cross sectional profile. The sixth conductor plate 56′ and the seventh conductor plate 57′ extend from two adjoining sides of the fourth conductor plate 54 that share neither the one side with the first conductor plate 51 and the one side with the second conductor plate 52. The sixth conductor plate 56′ and the seventh conductor plate 57′ are arranged while bent at an angle of about 90° with respect to the fourth conductor plate 54. An end of the sixth conductor plate 56′ facing the first conductor plate 51 is not coupled to the first conductor plate 51. Slit-shaped clearance (hereinafter called a “slit”) exists between the sixth conductor plate 56′ and the first conductor plate 51. In addition, an end of the seventh conductor plate 57′ facing the second conductor plate 52 is not coupled to the second conductor plate 52, and a slit exits between the seventh conductor plate 57′ and the second conductor plate 52. Moreover, an opposite end of the sixth conductor plate 56′ and an opposite end of the seventh conductor plate 57′ with respect to the fourth conductor plate 54 are not coupled to the fifth conductor plate 55.

In the embodiment, the first antenna element includes the first conductor plate 51, the second conductor plate 52, the fourth conductor plate 54, and the fifth conductor plate 55. The second antenna element includes the sixth conductor plate 56′ and the seventh conductor plate 57′. In the antenna element of the present embodiment, the first antenna element has a broadband characteristic exhibiting a variety of current distributions, and the second antenna element effects resonance at a specific band.

FIG. 27 is a graph showing a VSWR characteristic of the antenna element of the sixth embodiment. As shown in FIG. 27, the second antenna element exhibits a band of about 0.5 GHz around 3.4 GHz differing from the resonance frequency of the first antenna element and effects resonance at a band that is broader than the frequency band of the third embodiment (FIG. 12). The resonance frequency of the second antenna element changes according to the length of the sixth conductor plate 56′ and the length of the seventh conductor plate 57′ that extend from the fourth conductor plate 54. The frequency band satisfying VSWR≦3.5 somewhat includes the characteristic deterioration band stemming from the counter-resonance block but generally ranges from 1.86 GHz to 3.63 GHz. A band ratio is about 64.4%, which exhibits a broadband characteristic.

According to the embodiment, the first antenna element and the second antenna element each exhibit different resonance frequency bands. The resonance frequency can be controlled by adjusting the length of the sixth conductor plate 56′ and the length of the seventh conductor plate 57′ that make up the second antenna element. The area of the second antenna element is larger than the area of its counterpart described in connection with the third embodiment, and hence the resonance frequency band covered by the second antenna element becomes broader. Therefore, there can be provided an antenna element compatible with a broader frequency band and multiple bands.

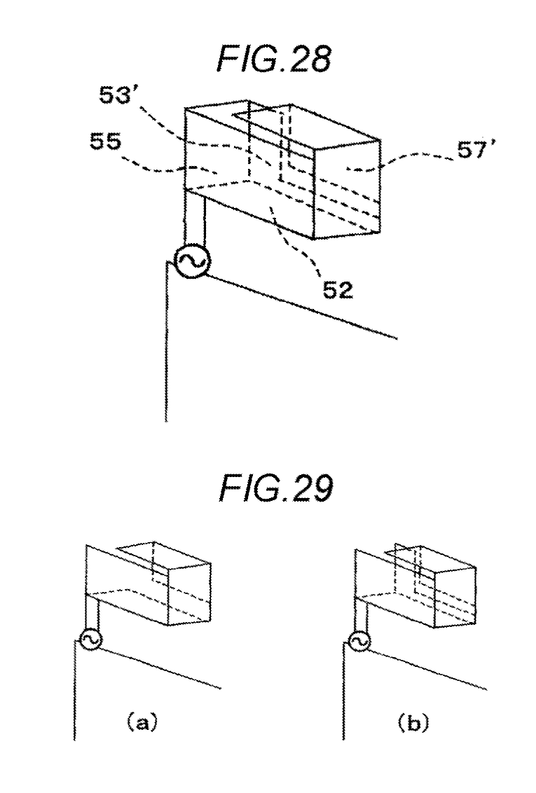

As shown in FIG. 28, the L-shaped conductor plate 53′ connected to the second conductor plate 52 and the fifth conductor plate 55 can also be interposed among the seventh conductor plate 57′, the second conductor plate 52, and the fifth conductor plate 55 with a slit between the conductor plate 53′ and the seventh conductor plate 57′. As shown in FIG. 29, there is no necessity to place the fifth conductor plate 55.

### Seventh Embodiment

An antenna element of a seventh embodiment is described. Of constituent elements configuring the antenna element of the seventh embodiment, constituent elements that are the same as those of the antenna element described in connection with the sixth embodiment are assigned the same reference numerals, and their repeated explanations are omitted here for brevity.

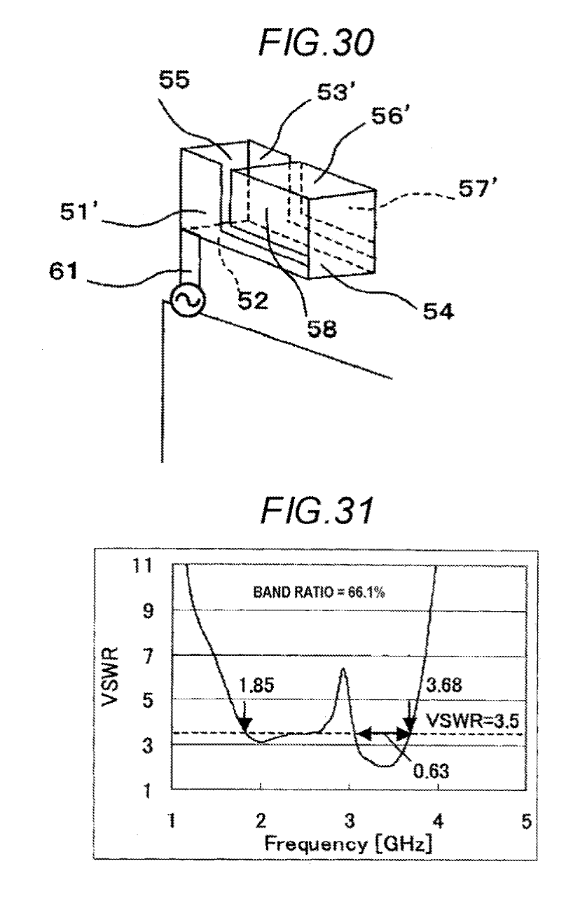

FIG. 30 is a perspective view showing the antenna element of the seventh embodiment. As shown in FIG. 30, the antenna element of the seventh embodiment includes a first conductor plate 51′, the second conductor plate 52, the third conductor plate 53′, the fourth conductor plate 54, the fifth conductor plate 55, the sixth conductor plate 56′, the seventh conductor plate 57′, an eighth conductor plate 58, and the feed conductor 61.

The first conductor plate 51′ is an L-shaped thin conductor arranged at a predetermined space apart from the ground plate. A long side of an outer periphery of the first conductor plate 51′ and one widthwise side (a long side) of the second conductor plate 52 are shared. The first conductor plate and the second conductor plate are arranged while bent at an angle of 90° with respect to each other. The second conductor plate 52 is a substantially rectangular, thin conductor; shares the long side of the outer periphery of the first conductor plate 51′; and is arranged while bent at an angle of about 90° with respect to the (direction of the plane) of the first conductor plate 51′.

The third conductor plate 53′ is an L-shaped thin conductor. A long side of an outer periphery of the third conductor plate 53′ and one of two widthwise sides (long side) of the second conductor plate 52 that is not shared by the first conductor plate 51 are shared. The third conductor plate 53′ is arranged while bent at an angle of about 90°. The third conductor plate 53′ is arranged so as to oppose the first conductor plate 51′ while bent at an angle of about 90° with respect to the second conductor plate 52.

The fourth conductor plate 54 is a substantially rectangular, thin conductor whose respect sides (three sides) are shared by one side (a short side) of the first conductor plate 51′, one side (a short side) of the second conductor plate 52, and one side (a short side) of the third conductor plate 53′. The fourth conductor plate 54 is provided on an end face apart from the feed conductor 61.

The fifth conductor plate 55 is a substantially rectangular, thin conductor whose respect sides (three sides) are shared by one side (a short side) of the first conductor plate 51′, one side (a short side) of the second conductor plate 52, and one side (a short side) of the third conductor plate 53′. The fifth conductor plate 55 is provided on an end face in proximity to the feed conductor 61.

The sixth conductor plate 56′ is a substantially rectangular, thin conductor; extends from one side of the fourth conductor plate 54 that is shared by neither the one side of the first conductor plate 51′, the one side of the second conductor plate 52, nor the one side of the third conductor plate 53′; and is placed while bent at an angle of about 90° with respect to the fourth conductor plate 54. The seventh conductor plate 57′ is a substantially rectangular, thin conductor; extends from one side of the fourth conductor plate 54 that shares one side of the first conductor plate 51′; and is placed while bent at an angle of about 90° with respect to the fourth conductor plate 54. The eighth conductor plate 58 is a substantially rectangular, thin conductor; extends from one side of the fourth conductor plate 54 that shares one side of the third conductor plate 53′; and is placed while bent at an angle of about 90° with respect to the fourth conductor plate 54.

The sixth conductor plate 56′, the seventh conductor plate 57′, and the eighth conductor plate 58 make up the second antenna element assuming a C-shaped cross sectional profile with adjoining long sides. An end of the eighth conductor plate 58 facing the first conductor plate 51′ is not coupled to the first conductor plate 51, and slit-shaped clearance (hereinafter called a “slit”) exists between the eighth conductor plate 58 and the first conductor plate 51′. An end of the seventh conductor plate 57′ facing the third conductor plate 53′ is not coupled to the third conductor plate 53, and the slit exists between the seventh conductor plate 57′ and the third conductor plate 53′. An opposite end of the sixth conductor plat 56′, an opposite end of the seventh conductor plate 57′, and an opposite end of the eighth conductor palate 58 with respect to the fourth conductor plate 54 are not coupled to the fifth conductor plate 55, either.

In the embodiment, the first antenna element includes the first conductor plate 51′, the second conductor plate 52, the third conductor plate 53′, the fourth conductor plate 54, and the fifth conductor plate 55. The second antenna element includes the sixth conductor plate 56′, the seventh conductor plate 57′, and the eighth conductor plate 58. In the antenna element of the present embodiment, the first antenna element has a broadband characteristic exhibiting a variety of current distributions, and the second antenna element effects resonance at a specific band.

FIG. 31 is a graph showing a VSWR characteristic of the antenna element of the seventh embodiment. As shown in FIG. 31, the second antenna element exhibits a band of about 0.63 GHz around 3.4 GHz differing from the resonance frequency of the first antenna element and effects resonance at a band that is broader than the band of the sixth embodiment (FIG. 12). The resonance frequency of the second antenna element changes according to the length of the sixth conductor plate 56′, the length of the seventh conductor plate 57′, and the length of the eighth conductor plate 58 that extend from the fourth conductor plate 54. The frequency band satisfying VSWR≦3.5 somewhat includes the characteristic deterioration band stemming from the counter-resonance block but generally ranges from 1.85 GHz to 3.68 GHz. A band ratio is about 66.1%, which exhibits a broadband characteristic.

According to the embodiment, the first antenna element and the second antenna element each exhibit different resonance frequency bands. The resonance frequency can be controlled by adjusting the length of the sixth conductor plate 56′, the length of the seventh conductor plate 57′, and the length of the eighth conductor plate 58 that make up the second antenna element. The area of the second antenna element is larger than the area of its counterpart described in connection with the third embodiment and the sixth embodiment, and hence the resonance frequency band covered by the second antenna element becomes broader. Therefore, there can be provided an antenna element compatible with a broader frequency band and multiple bands.

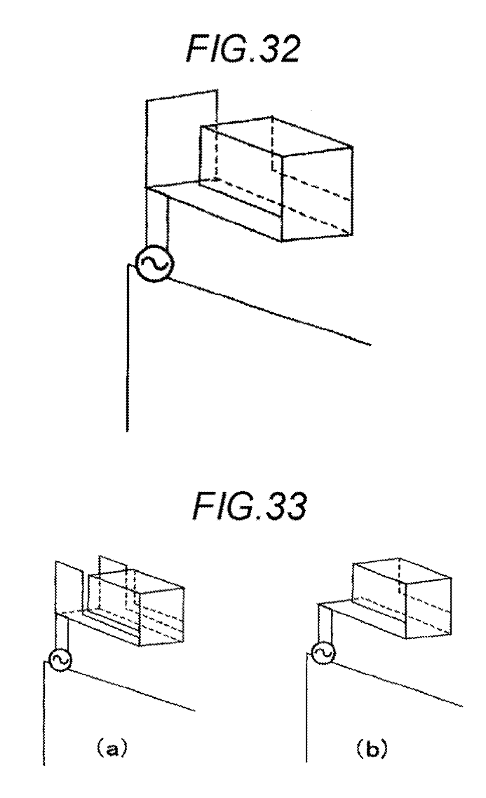

As shown in FIG. 32, the first conductor plate 51′ and the third conductor plate 53′ do not always need to be provided. As shown in FIG. 33, the fifth conductor plate 55 does not always need to be provided.

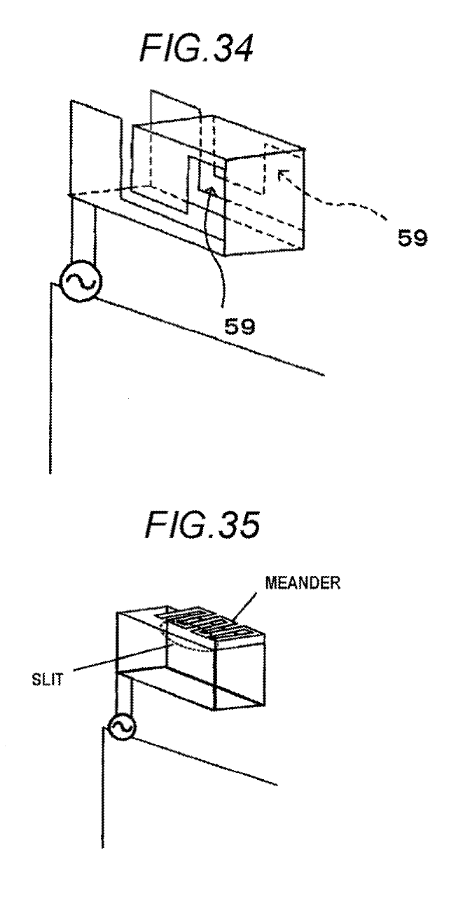

In the conductor plate configuring the second antenna element or the third antenna element of the previously-described third through sixth embodiments, a defect 59 can be provided in one of a side extending form the fourth conductor plate 54, as exemplified in FIG. 34. Since the area of the second antenna element is reduced as a result of provision of the defect 59, the resonance frequency of the second element changes.

The conductor plate configuring the second antenna element or the third antenna element of the third to sixth embodiments is not limited to the shape of the thin plate but can also be replaced with a meandering structure that electrically makes the element length longer by means of an elongated line. FIG. 35 shows that the second antenna element belonging to the antenna element of the third embodiment shown in FIG. 18 has a meandering structure. As shown in FIG. 35, a slit is provided among the first conductor plate 51, the third conductor plate 53, and a meandering element, whereby it becomes possible to acquire a resonance frequency that is lower than that achieved when the second antenna element is made up of the conductor plate. Therefore, design flexibility of the antenna element is enhanced.

The space defined by at least the three conductor plates can also be filled with a dielectric material or a magnetic material.

### Eighth Embodiment

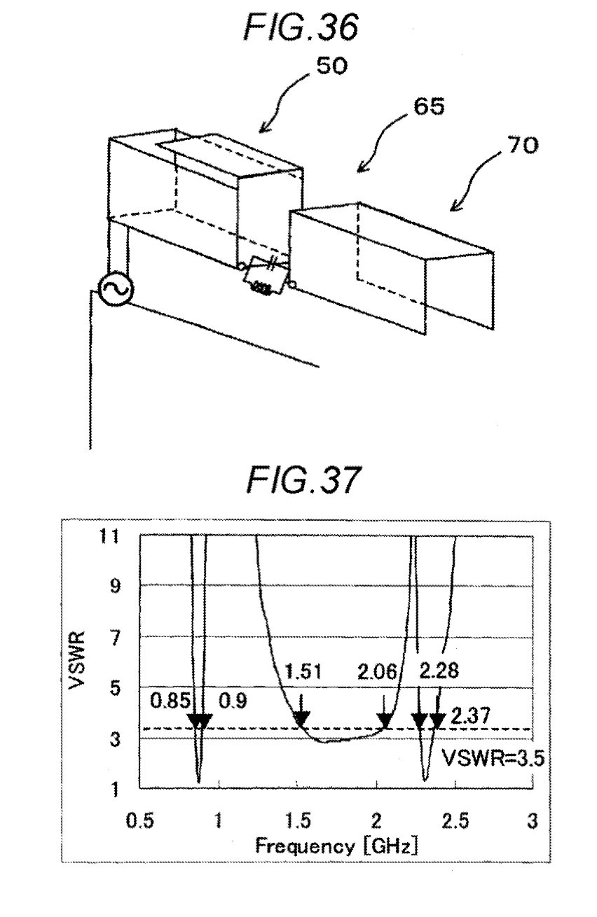

An antenna element of an eighth embodiment includes any one of the antenna elements described in connection with the first through sixth embodiments, another antenna element, and a parallel resonance circuit connected in series with an intermediate point between the antenna elements. FIG. 36 is a perspective view showing the antenna element of the eighth embodiment. In the antenna element shown in FIG. 36, a fourth antenna element 70 is provided on a side of the antenna element 50 of the third embodiment shown in FIG. 11 facing the fourth conductor plate 54, by way of a parallel resonance circuit 65.

The fourth antenna element 70 is made up of three substantially rectangular, thin conductors and has a C-shaped cross sectional profile. The parallel resonance circuit 65 is made up of a chip capacitor and chip inductance that are connected in parallel to each other and fulfills a filtering function of letting an electric current flow to the fourth antenna element 70 in only the vicinity of a predetermined frequency. FIG. 37 is a graph showing a VSWR characteristic of the antenna element of the eighth embodiment. An 800 MHz band shown in FIG. 37 originates from the fourth antenna element. A band ranging from 1.5 GHz to 2.0 GHz originates from the first antenna element belonging to the antenna element 50. A 2.3 GHz band originates from the second antenna element belonging to the antenna element 50.

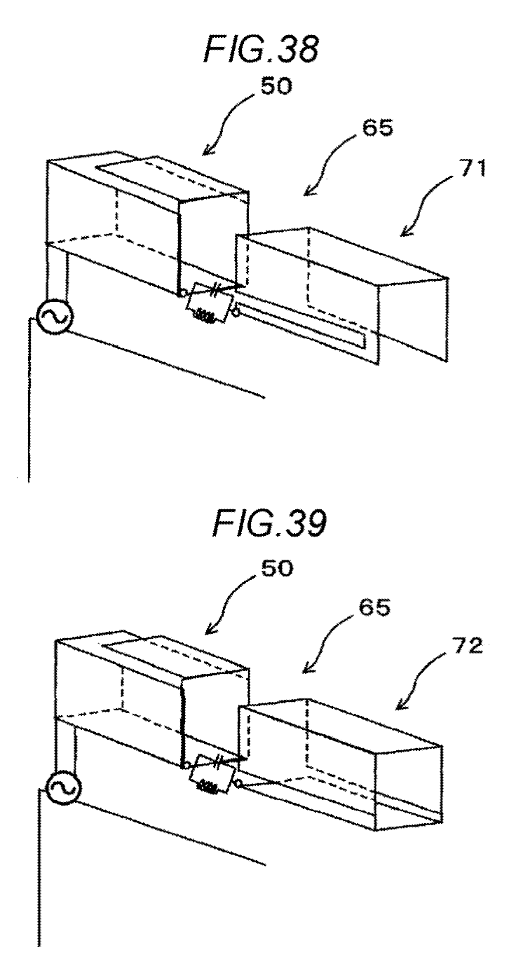

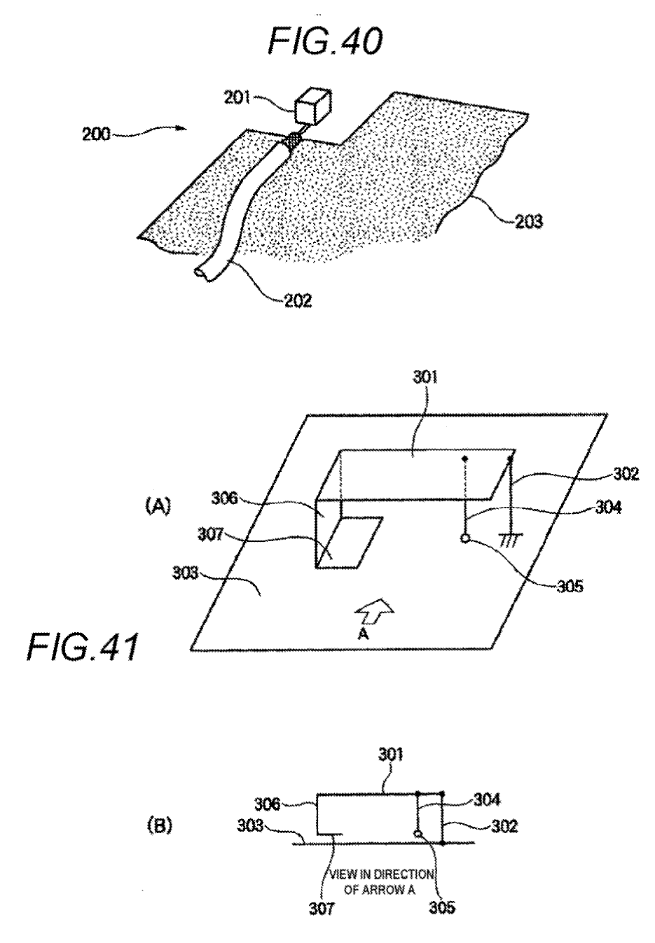

According to the present embodiment, a plurality of antenna elements are connected in series with each other by way of the parallel resonance circuit. Hence, there can be provided an antenna element compatible with a broader frequency band and multiple bands. As shown in FIGS. 38 and 39, a slit can also be provided in a portion of the fourth antenna element so as to extend from a connection to the parallel resonance circuit 65 toward the element. The fourth antenna element can cope with a low frequency band as a result of a slit being provided.

The present invention is not limited to the previous embodiments and can be carried out in various forms without departing the range of gist of the invention.

Specifically, in addition to being provided in a foldable portable radio, such as those described in connection with the first and second embodiments, the antenna element of the present invention can also be arranged at an upper end of a straight-type or slidable portable radio. In the case of the slidable radio, an advantage that is substantially identical with that yielded when the radio is closed is yielded. Further, the conductor element configuring the antenna element can also be a flexible board in place of a board-shaped conductor plate.

Although the present invention has been described in detail by reference to a specific embodiments, it is manifest to persons who are skilled in the art that the present invention be susceptible to various alterations or modifications without departing the spirit and scope of the present invention. In the first and second embodiments, the antenna elements 5 and 6 are secured by means of; for instance, the insulative holder exhibiting a low dielectric constant. However, means for securing the antenna elements is not limited to such a configuration, so long as a similar advantage is yielded.

Although the present invention has been described in detail and by reference to the specific embodiments, it is evident for the artisans skilled in the art that the present invention be liable to various modifications or alterations without departing the spirit and scope of the present invention.

The present patent application is based on Japanese Patent Application (P2008-061306) filed on Mar. 11, 2008 in Japan, the entire subject matter of which is incorporated herein by reference.

### INDUSTRIAL APPLICABILITY

As mentioned above, according to the present invention, a rectangular parallelepiped antenna element is made by folding a board-shaped monopole element assuming a rectangular shape into two faces or more. The antenna element is advantageous over a cubic antenna element in terms of an antenna characteristic. Hence, a compact, high gain, and broadband antenna element becomes possible. Hence, the antenna element is suitable for use with a plurality of radio systems capable of addition of features; for instance, a GPS and a Bluetooth and, by extension, is suitable for application to an antenna, such as a portable phone or a portable radio such as a PDA.

1. An antenna element comprising:
a substantially rectangular first conductor plate arranged at a predetermined space apart from a ground plate;
a substantially rectangular second conductor plate that shares a first long side of the first conductor plate and that is arranged at an angle of about 90° with respect to the first conductor plate; and
a substantially rectangular third conductor plate that shares a second long side of the second conductor plate opposing the first long side of the second conductor plate shared by the first conductor plate and that is arranged at an angle of about 90° so as to oppose the first conductor plate, wherein
the first long side of the first conductor plate is arranged to be parallel with and separate at the predetermined space apart from the ground plate, and
electric power is fed to the first conductor plate from a substantial corner of the ground plate.

2. A portable radio including the antenna element defined in claim 1, a first housing accommodating the ground plate of the portable radio, a second housing having a first antenna element, and a hinge that connects the first housing to the second housing and that holds the second housing rotatably with respect to the first housing, wherein
the antenna element is provided in vicinity of the hinge.

3. The portable radio according to claim 2, wherein the first antenna element provided in the second housing is capacitively coupled to any one of the first conductor plate, the second conductor plate, and the third conductor plate provided in the antenna element, thereby operating as a composite antenna.

4. The portable radio according to claim 2, wherein the antenna element has a fourth conductor plate sharing one side of the first conductor plate, one side of the second conductor plate, and one side of the third conductor plate.

5. The antenna element according to claim 1, further comprising a fourth conductor plate sharing one side of the first conductor plate, one side of the second conductor plate, and one side of the third conductor plate.

6. The antenna element according to claim 5, further comprising a fifth conductor plate that is arranged at a position opposing the fourth conductor plate with the first conductor plate, the second conductor plate, and the third conductor plate sandwiched between the fourth and fifth conductor plates and that shares one side of the first conductor plate, one side of the second conductor plate, and one side of the third conductor plate, wherein
the fifth conductor plate is arranged on a side surface of the first conductor plate in proximity to a feeding point on the first conductor plate where electric power is fed from the ground plate.

7. The antenna element according to claim 5, wherein the fourth conductor plate is arranged on a side surface of the first conductor plate apart from a feeding point on the first conductor plate where electric power is fed from the ground plate, and
the antenna element includes:
a sixth conductor plate that extends from one side of the fourth conductor plate which shares neither one side of the first conductor plate, one side of the second conductor plate, nor one side of the third conductor plate and that is arranged at an angle of 90° with respect to the fourth conductor plate; and
a slit existing between the sixth conductor plate and the first conductor plate and between the sixth conductor plate and the third conductor plate.

8. The antenna element according to claim 7, wherein the one side of the sixth conductor plate extending from the fourth conductor plate has a defect in part.

9. The antenna element according to claims 7, further comprising a fifth conductor plate that is arranged at a position opposing the fourth conductor plate with the first conductor plate, the second conductor plate, and the third conductor plate sandwiched between the fourth and fifth conductor plates and that shares one side of the first conductor plate, one side of the second conductor plate, and one side of the third conductor plate.

10. The antenna element according to claim 7, wherein the sixth conductor plate is formed from an elongated line into a meander shape.

11. The antenna element according to claim 1, wherein a space defined by the first conductor plate, the second conductor plate, and the third conductor plate is filled with a dielectric material or a magnetic material.

12. An antenna element comprising:
a substantially rectangular first conductor plate arranged at a predetermined space apart from a ground plate;
a substantially rectangular second conductor plate that shares a first long side of the first conductor plate and that is arranged at an angle of about 90° with respect to the first conductor plate;
a fourth conductor plate that is provided on a side surface of the first conductor plate apart from a feeding point where electric power is fed from the ground plate and that shares one side of the first conductor plate and one side of the second conductor plate; and
a sixth conductor plate and a seventh conductor plate that extend from two adjoining sides of the fourth conductor plate which are shared by neither the one side of the first conductor plate nor the one side of the second conductor plate and that are arranged at an angle of about 90° with respect to the fourth conductor plate, wherein
the first long side of the first conductor plate is arranged to be parallel with and separate at the predetermined space apart from the ground plate.

13. The antenna element according to claim 12, further comprising a third conductor plate that shares a second long side of the second conductor plate opposing the first long side of the second conductor plate shared by the first conductor plate and that is arranged at an angle of about 90° so as to oppose the first conductor plate.

14. The antenna element according to claim 12, wherein the sixth conductor plate and the seventh conductor plate share one side with each other, to thus form an L-shaped folded portion.

15. The antenna element according to claim 12, wherein a defect is provided in a part of a side of at least the sixth conductor plate or the seventh conductor plate extending from the fourth conductor plate.

16. The antenna element according to claim 12, further comprising a fifth conductor plate that is arranged at a position opposing the fourth conductor plate with the first conductor plate and the second conductor plate sandwiched between the fourth and fifth conductor plates and that shares the one side of the first conductor plate and the one side of the second conductor plate.

17. The antenna element according to claim 12, wherein the sixth conductor plate or the seventh conductor plate is formed from an elongated line into a meander shape.

18. The antenna element according to claim 12, wherein a space defined by the first conductor plate, the second conductor plate, and the fourth conductor plate is filled with a dielectric material or a magnetic material.

19. An antenna element comprising:
a substantially rectangular first conductor plate arranged at a predetermined space apart from a ground plate;
a fourth conductor plate that shares a first short side of the first conductor plate apart from a feeding point on the first conductor plate where electric power is fed from the ground plate and that is arranged at an angle of about 90° with respect to the first conductor plate;
a substantially rectangular third conductor plate that shares a second short side opposing the first short side of the fourth conductor plate shared by the first conductor plate and that is arranged at an angle of about 90° so as to oppose the first conductor plate; and
a sixth conductor plate and a seventh conductor plate that extend from two opposing sides of the fourth conductor plate which share neither the one side of the first conductor plate nor the one side of the third conductor plate and that are arranged at an angle of about 90° with respect to the fourth conductor plate, wherein
a long side of the first conductor plate in proximity to the ground plate is arranged to be parallel with and separate at the predetermined space apart from the ground plate.

20. The antenna element according to claim 19, further comprising a second conductor plate that shares a part of a long side of the first conductor plate and a part of a long side of the third conductor plate and that is arranged at an angle of about 90° with respect to the first conductor plate and the third conductor plate.

21. The antenna element according to claim 19, wherein a defect is provided in a part of a side of at least the sixth conductor plate or the seventh conductor plate extending from the fourth conductor plate.

22. The antenna element according to claim 19, further comprising a fifth conductor plate that is arranged at a position opposing the fourth conductor plate with the first conductor plate and the third conductor plate sandwiched between the fourth and fifth conductor plates and that shares the one side of the first conductor plate and the one side of the third conductor plate.

23. The antenna element according to claim 19, wherein the sixth conductor plate or the seventh conductor plate is formed from an elongated line into a meandering shape.

24. The antenna element according to claim 19, wherein a space defined by the first conductor plate, the third conductor plate, and the fourth conductor plate is filled with a dielectric material or a magnetic material.

25.-30. (canceled)
